(19) United States
(12) Patent Application Publication
(10) Pub. No.: US 2025/0349101 A1
(43) Pub. Date: Nov. 13, 2025

(54) SEGMENTATION OF MEDICAL IMAGES

(71) Applicant: Bayer Aktiengesellschaft, Leverkusen (DE)

(72) Inventors: Josef CERSOVSKY, Leverkusen (DE); Jens HOOGE, Leverkusen (DE); Seyed Sadegh MOHAMMADI, Leverkusen (DE); Guillermo JIMENEZ, Sent Juan Despi (ES); Pedro LOURO COSTA OSORIO, Sant Juan Despi (ES); Javier MONTALT TORDERA, Sant Juan Despi (ES)

(21) Appl. No.: 19/084,033

(22) Filed: Mar. 19, 2025

(30) Foreign Application Priority Data
Mar. 20, 2024 (EP) 24164697.5
Jun. 11, 2024 (EP) 24181271.8

(51) Int. Cl. G06V 10/26; G06V 10/28; G06V 10/774

(52) U.S. Cl. CPC G06V 10/26; G06V 10/28; G06V 10/774; G06V 2201/03

(57) ABSTRACT

Systems, methods, and computer programs disclosed herein relate to the segmentation of medical images.

### FIELD OF THE DISCLOSURE

Systems, methods, and computer programs disclosed herein relate to the segmentation of medical images.

### BACKGROUND

Medical imaging plays a crucial role in diagnosis, treatment planning, and monitoring of various diseases and conditions. Segmentation of medical images is of paramount importance as it enables the accurate delineation of anatomical structures and pathological regions. This, in turn, aids healthcare professionals in making informed decisions, leading to improved patient outcomes.

Traditional manual segmentation is time-consuming, subjective, and prone to inter-observer variability. Automatic segmentation addresses these limitations by providing efficient, consistent, and reproducible delineation of structures within medical images. This not only saves time but also enhances the accuracy and reliability of diagnostic and treatment processes.

The segmentation of medical images can be automated, e.g., by employing machine learning techniques, thereby providing accurate and reproducible delineation of anatomical structures, lesions, and other clinically relevant regions within diverse medical imaging modalities.

For example, US20210103756A1 discloses a method for automatically segmenting medical images using a trained machine learning model that has been trained on manually segmented medical images. Manually segmenting medical images requires specialized expertise from healthcare professionals, such as radiologists or medical imaging specialists. Their time is limited, and the process of meticulously outlining regions of interest in medical images is labor-intensive and demands a high level of domain knowledge. Even among experts, there can be variability in how regions of interest are delineated. This variability can introduce inconsistencies and biases in the manually segmented data, impacting the quality and generalization of the machine learning model. Manually segmented medical images are often scarce and challenging to acquire in large quantities, especially for rare conditions or specific patient demographics. As a result, building comprehensive and diverse training datasets for training machine learning model becomes a significant hurdle.

Zero-shot segmentation is a concept in machine learning where a model is trained to segment objects or regions of interest in images that it has not seen during training. This is particularly useful in scenarios where labeled training data is scarce or unavailable. The “zero-shot” term implies that the model does not need any prior examples (or “shots”) of the specific class it is asked to segment. Instead, it leverages knowledge learned from related tasks or classes to perform segmentation on new, unseen classes. S. Roy et al. disclose a method for zero-shot segmentation of medical images (S. Roy et al.: SAM.MD: Zero-shot medical image segmentation capabilities of the Segment Anything Model, arXiv:2304.05396v1). However, the process disclosed by S. Roy et al. does not work without manually segmented images; the prompts for generating the segmented images are generated based on manually segmented images.

It would be desirable to be able to segment medical images with a high degree of accuracy without the need for manually segmented images.

### SUMMARY

This task is addressed by the subject matter of the independent claims of the present disclosure. Preferred embodiments are defined in the dependent claims, the description, and the drawings.

In a first aspect, the present disclosure relates to a computer-implemented method comprising the steps:
providing a training data set, the training data set comprising a variety of medical images,
for each medical image of the variety of medical images: generating a semantic representation of the medical image using an image encoder,
providing a conditional generative model,
training the conditional generative model on the training data set to reconstruct the medical images in a self-supervised training procedure using the semantic representations as conditions,
receiving an unseen medical image,
generating a semantic representation of the unseen medical image using the image encoder,
inputting the unseen medical image into the trained conditional generative model, thereby causing the trained conditional generative model to reconstruct the unseen medical image, wherein the semantic representation of the unseen medical image is used as condition,
determining one or more attention maps resulting at least in part from the reconstruction of the unseen medical image by the trained conditional generative model,
generating a segmented medical image based on the one or more attention maps,
outputting the segmented medical image.

In another aspect, the present disclosure provides a computer system comprising:
a processor; and
a memory storing an application program configured to perform, when executed by the processor, an operation, the operation comprising:
   providing a training data set, the training data set comprising a variety of medical images,
   for each medical image of the variety of medical images: generating a semantic representation of the medical image using an image encoder,
   providing a conditional generative model,
   training the conditional generative model on the training data set to reconstruct the medical images in a self-supervised training procedure using the semantic representations as conditions,
   receiving an unseen medical image,
   generating a semantic representation of the unseen medical image using the image encoder,
   inputting the unseen medical image into the trained conditional generative model, thereby causing the trained conditional generative model to reconstruct the unseen medical image, wherein the semantic representation of the unseen medical image is used as condition,
   determining one or more attention maps resulting at least in part from the reconstruction of the unseen medical image by the trained conditional generative model,
   generating a segmented medical image based on the one or more attention maps,
   outputting the segmented medical image.

In another aspect, the present disclosure provides a non-transitory computer readable storage medium having stored thereon software instructions that, when executed by a processor of a computer system, cause the computer system to execute the following steps:
providing a training data set, the training data set comprising a variety of medical images,
for each medical image of the variety of medical images: generating a semantic representation of the medical image using an image encoder,
providing a conditional generative model,
training the conditional generative model on the training data set to reconstruct the medical images in a self-supervised training procedure using the semantic representations as conditions,
receiving an unseen medical image,
generating a semantic representation of the unseen medical image using the image encoder,
inputting the unseen medical image into the trained conditional generative model, thereby causing the trained conditional generative model to reconstruct the unseen medical image, wherein the semantic representation of the unseen medical image is used as condition,
determining one or more attention maps resulting at least in part from the reconstruction of the unseen medical image by the trained conditional generative model,
generating a segmented medical image based on the one or more attention maps,
outputting the segmented medical image.

### BRIEF DESCRIPTION OF THE DRAWINGS

FIG. 1 shows schematically by way of example the training of the machine learning model of the present disclosure.

FIG. 2 shows schematically by way of example the segmentation of an unseen medical image using the trained conditional generative model.

FIG. 3 shows schematically by way of example, the computer-implemented method of the present disclosure in from of a flow chart.

FIG. 4 illustrates a computer system according to some example implementations of the present disclosure in more detail.

### DETAILED DESCRIPTION

Various example embodiments will be more particularly elucidated below without distinguishing between the aspects of the disclosure (method, computer system, computer-readable storage medium). On the contrary, the following elucidations are intended to apply analogously to all the aspects of the disclosure, irrespective of in which context (method, computer system, computer-readable storage medium) they occur.

If steps are stated in an order in the present description or in the claims, this does not necessarily mean that the disclosure is restricted to the stated order. On the contrary, it is conceivable that the steps can also be executed in a different order or else in parallel to one another, unless, for example one step builds upon another step, this requiring that the building step be executed subsequently (this being, however, clear in the individual case). The stated orders may thus be exemplary embodiments of the present disclosure.

As used herein, the articles “a” and “an” are intended to include one or more items and may be used interchangeably with “one or more” and “at least one.” As used in the specification and the claims, the singular form of “a”, “an”, and “the” include plural referents, unless the context clearly dictates otherwise. Where only one item is intended, the term “one” or similar language is used. Also, as used herein, the terms “has”, “have”, “having”, or the like are intended to be open-ended terms. Further, the phrase “based on” is intended to mean “based at least partially on” unless explicitly stated otherwise.

Some implementations of the present disclosure will be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art.

The terms used in this description have the meaning that they have in the prior art (in particular in the prior art cited in this description), unless otherwise stated in this description.

The present disclosure provides a means for segmenting medical images.

The term “image” as used herein means a data structure that represents a spatial and/or temporal distribution of a physical signal. The distribution may be of any dimension, for example 1D, 2D, 3D, 4D or any higher dimension. The distribution may be of any shape, for example forming a grid and thereby defining pixels or voxels, the grid being possibly irregular or regular. The physical signal may be any signal, for example proton density, tissue echogenicity, tissue radiolucency, measurements related to blood flow, information of rotating hydrogen nuclei in a magnetic field, color, level of gray, depth, surface or volume occupancy, such that the image may be a 2D or 3D RGB/grayscale/depth image, or a 3D surface/volume occupancy model. An image is usually composed of discrete image elements (e.g., pixels for 2D images, voxels for 3D images, doxels for 4D images).

A “medical image” is a visual representation of the human body or a part thereof or a visual representation of the body of an animal or a part thereof. Medical images may be used, e.g., for diagnostic and/or treatment purposes. A widely used format for digital medical images is the DICOM format (DICOM: Digital Imaging and Communications in Medicine). There are of course many other image file formats (see, e.g., https://developer.mozilla.org/en-US/docs/Web/Media/Formats/Image_types) and the present invention is not limited to any specific image file format.

Techniques for generating medical images may include X-ray radiography, computerized tomography, fluoroscopy, magnetic resonance imaging, ultrasonography, endoscopy, elastography, tactile imaging, thermography, microscopy, positron emission tomography, optical coherence tomography, fundus photography, and others.

Examples of medical images include CT (computer tomography) scans, X-ray images, MRI (magnetic resonance imaging) scans, PET (positron emission tomography) images, fluorescein angiography images, OCT (optical coherence tomography) scans, histological images, ultrasound images, fundus images and/or others.

In an embodiment of the present disclosure, the medical image is a microscopic image, such as a whole slide histological image of a tissue of a human body. The histological image may be an image of a stained tissue sample. One or more dyes may be used to create the stained image. Usual dyes are hematoxylin and eosin.

In another embodiment of the present disclosure, the medical image is a radiological image. “Radiology” is the branch of medicine concerned with the application of electromagnetic radiation and mechanical waves (including, for example, ultrasound diagnostics) for diagnostic, therapeutic and/or scientific purposes. In addition to X-rays (radiography), other ionizing radiation such as gamma rays or electrons are also used. Since a primary purpose is imaging, other imaging procedures such as sonography and magnetic resonance imaging (MRI) are also included in radiology, although no ionizing radiation is used in these procedures. Thus, the term “radiology” as used in the present disclosure includes, in particular, the following examination procedures: radiography, computed tomography, magnetic resonance imaging, sonography, positron emission tomography.

The radiological image may be, e.g., a 2D, 3D or 4D CT scan or MRI scan. The radiological image may be an image generated using a contrast agent or without a contrast agent. It may also be multiple images, one or more of which were generated using a contrast agent and one or more of which were generated without a contrast agent.

“Contrast agents” are substances or mixtures of substances that improve the depiction of structures and functions of the body in medical examinations.

In computed tomography, iodine-containing solutions are usually used as contrast agents. In magnetic resonance imaging (MRI), superparamagnetic substances (for example iron oxide nanoparticles, superparamagnetic iron-platinum particles (SIPPs)) or paramagnetic substances (for example gadolinium chelates, manganese chelates, hafnium chelates) are usually used as contrast agents. In the case of sonography, liquids containing gas-filled microbubbles are usually administered intravenously. In positron emission tomography (PET) radiotracers are usually used as contrast agents. Contrast in PET images is caused by the differential uptake of the radiotracer in different tissues or organs. A radiotracer is a radioactive substance that is injected into the examination object. The radiotracer emits positrons. When a positron collides with an electron within the examination region of the examination object, both particles are annihilated, producing two gamma rays that are emitted in opposite directions. These gamma rays are then detected by a PET scanner, allowing the creation of detailed images of the body's internal functioning.

Examples of contrast agents can be found in the literature (see for example A. S. L. Jascinth et al.: Contrast Agents in computed tomography: A Review, Journal of Applied Dental and Medical Sciences, 2016, vol. 2, issue 2, 143-149; H. Lusic et al.: X-ray-Computed Tomography Contrast Agents, Chem. Rev. 2013, 113, 3, 1641-1666; https://www.radiology.wisc.edu/wp-content/uploads/2017/10/contrast-agents-tutorial.pdf, M. R. Nouh et al.: Radiographic and magnetic resonances contrast agents: Essentials and tips for safe practices, World J Radiol. 2017 Sep. 28; 9(9): 339-349; L. C. Abonyi et al.: Intravascular Contrast Media in Radiography: Historical Development & Review of Risk Factors for Adverse Reactions, South American Journal of Clinical Research, 2016, vol. 3, issue 1, 1-10; ACR Manual on Contrast Media, 2020, ISBN: 978-1-55903-012-0; A. Ignee et al.: Ultrasound contrast agents, Endosc Ultrasound. 2016 November-December; 5(6): 355-362; J. Trotter et al.: Positron Emission Tomography (PET)/Computed Tomography (CT) Imaging in Radiation Therapy Treatment Planning: A Review of PET Imaging Tracers and Methods to Incorporate PET/CT, Advances in Radiation Oncology (2023) 8, 101212).

The term “segmentation” refers to the process of dividing an image into several segments, also known as image segments, image regions or image objects. Segmentation is typically used to locate objects and boundaries (lines, curves, etc.) in images. From a segmented image, the localized objects can be separated from the background, visually highlighted (e.g.: colored), measured, counted, or otherwise quantified.

Segmentation usually involves assigning a label to each image element (e.g., pixel or voxel or doxel, as the case may be) of an image such that image elements with the same label have certain features in common, e.g., belong to the same object (e.g., organ and/or tissue type).

According to the present disclosure, segmented images are generated using one or more machine learning models.

The term “machine learning model”, as used herein, may be understood as a computer implemented data processing architecture. The machine learning model can receive input data and provide output data based on that input data and on parameters of the machine learning model (model parameters). The machine learning model can learn a relation between input data and output data through training. In training, parameters of the machine learning model may be adjusted in order to provide a desired output for a given input.

A process of training a machine learning model may involve providing a machine learning algorithm (that is the learning algorithm) with training data to learn from. The term “trained machine learning model” refers to the model artifact that is created by the training process. The training data usually includes the correct answer, which is referred to as the target. The learning algorithm finds patterns in the training data that map input data to the target, and it outputs a trained machine learning model that captures these patterns.

In an example training process, training data are inputted into the machine learning model and the machine learning model generates an output. The output is compared with the (known) target. Parameters of the machine learning model are modified in order to reduce the deviations between the output and the (known) target to a (defined) minimum.

In general, a loss function can be used for training, where the loss function can quantify the deviations between the output and the target. The loss function may be chosen in such a way that it rewards a wanted relation between output and target and/or penalizes an unwanted relation between an output and a target. Such a relation can be, e.g., a similarity, or a dissimilarity, or another relation.

A loss function can be used to calculate a loss for a given pair of output and target. The aim of the training process can be to modify (adjust) parameters of the machine learning model in order to reduce the loss to a (defined) minimum.

The machine learning model of the present disclosure is or comprises a conditional generative model. In other words: according to the present disclosure, segmented images are generated using a conditional generative model.

A “generative model” is a type of machine learning model that is designed to learn and generate new data that resembles the training data it was trained on. Generative models capture the underlying distribution of the training data and can generate samples from that distribution.

A “conditional generative model” is a type of generative model that generates data (in this case, a reconstructed medical image) given certain conditions or constraints. Conditional generative models take additional input in the form of a condition that guides the process of image generation. In general, this condition can be anything that provides some sort of context for the generation process, such as a class label, a text description, another image, or any other piece of information. In the case of the present disclosure, a semantic representation of a medical image is used as the condition.

In an embodiment of the present disclosure, the conditional generative model is or comprises a diffusion model.

Diffusion models focus on modeling the step-by-step evolution of a data distribution from a “simple” starting point to a “more complex” distribution. The underlying concept of diffusion models is to transform a simple and easily sampleable distribution, for example a Gaussian distribution, into a more complex data distribution of interest. This transformation is achieved through a series of invertible operations. Once the model learns the transformation process, it can generate new samples by starting from a point in the simple distribution and gradually “diffusing” it to the desired complex data distribution.

A diffusion model usually comprises a noising model and a denoising model.

The noising model usually comprises a plurality of noising stages. The noising model is configured to receive input data (e.g., an image) and produce noisy data in response to receipt of the input data. The noising model introduces noise to the input data to obfuscate the input data after a number of stages, or “timesteps” T. The noising model can be or can include a finite number of steps T or an infinite number of steps (T→∞). The noising model may have the same weights/architectures for all timesteps or different weights/architectures for each timestep. The number of timesteps can be global (i.e., timesteps are the same for all pixels of an image) or local (e.g., each pixel in an image might have a different timestep).

The denoising model is configured to reconstruct the input data from the noisy data. The denoising model is configured to produce samples matching the input data after a number of stages.

For example, the diffusion model may include Markov chains at the noising model and/or denoising model. The diffusion models may be implemented in discrete time, e.g., where each layer corresponds to a timestep. The diffusion model may also be implemented in arbitrarily deep (e.g., continuous) time.

Diffusion models can be conceptually similar to a variational autoencoder (VAE) whose structure and loss function provides for efficient training of arbitrarily deep (e.g., infinitely deep) models. The diffusion model can be trained using variational inference, for example.

The diffusion model can be a Latent Diffusion Model (LDM). In such a model, the diffusion approach in the case of an image is not performed in real space (e.g., pixel space or voxel space or doxel space, as the case may be), but in so-called latent space based on a representation of the image, usually a compressed representation (see, e.g., R. Rombach et al.: High-Resolution Image Synthesis with Latent Diffusion Models, arXiv:2112.10752v2).

The diffusion model may be a Denoising Diffusion Probabilistic Model (DDPM). DDPMs are a class of generative models that work by iteratively adding noise to input data (e.g., an image or a compressed representation) and then learning to denoise from the noisy signal to generate new samples (see, e.g., J. Ho et al.: Denoising Diffusion Probabilistic Models, arXiv:2006.11239v2).

The diffusion model may be a Score-based Generative Model (SGM). In SGMs the data is perturbed with random Gaussian noise of various magnitudes. With the gradient of log probability density as score function, samples are generated towards decreasing noise levels and the model is trained by estimating the score functions for noisy data distribution (see, e.g., Y. Song et al.: Score-Based Generative Modeling through Stochastic Differential Equations, arXiv:2011.13456v2).

The diffusion model may be a Denoising Diffusion Implicit Model (DDIM) (see, e.g.: J. Song et al.: Denoising Diffusion Implicit Models, arXiv:2010.02502v4). A critical drawback of DDPMs is that they require many iterations to produce a high-quality sample. For DDPMs, this is because the generative process (from noise to data) approximates the reverse of the forward diffusion process (from data to noise), which could have thousands of steps; iterating over all the steps is required to produce a single sample. DDIMs are implicit probabilistic models that are closely related to DDPMs, in the sense that they are trained with the same objective function. DDIMs allow for much faster sampling while keeping an equivalent training objective. They do this by estimating the addition of multiple Markov chain steps and adding them all at once. DDIMs construct a class of non-Markovian diffusion processes which makes sampling from reverse process much faster. This modification in the forward process preserves the goal of DDPM and allows for deterministically encoding an image to the noise map.

Unlike DDPMs, DDIMs enable control over image synthesis owing to the latent space flexibility (attribute manipulation) (see, e.g., K. Preechakul et al.: Diffusion autoencoders: Toward a meaningful and decodable representation, arXiv:2111.15640v3). With DDIM, it is possible to run the generative process backward deterministically to obtain the noise map x_{T}, which represents the latent variable or encoding of a given image x₀. In this context, DDIM can be thought of as an image decoder that decodes the latent code x_{T} back to the input image. This process can yield a very accurate reconstruction; however, x_{T} still does not contain high-level semantics as would be expected from a meaningful representation.

In an embodiment of the present disclosure, the conditional generative model is a conditional diffusion model.

In a conditional diffusion model, a condition is used to denoise latent data and reconstruct the input data (see, e.g., P. Dhariwal, A. Nichol: “Diffusion models beat GANs on image synthesis,” arXiv:2105.05233v4). One benefit of conditioning the diffusion model with information-rich representations is a more efficient denoising process.

In general, such a condition can be based on a text (e.g., text-to-image), on an image, on audio data, and/or on other information. In the case of the present disclosure, a semantic representation of a medical image is used as a condition for reconstructing the medical image.

The conditional generative model is trained on a training data set.

The training data set comprises a variety of medical images. Each medical image of the variety of medical images represents a human being or a part thereof or an animal (preferably a mammal) or part thereof.

The medical images may represent one or more (e.g., different) examination areas of a plurality of humans and/or animals.

The examination area can be or comprise a thorax, breast, stomach, liver, kidney, heart, lung, brain, stomach, bladder, prostate, intestine, eye, or a part of said parts or another part of the body of a human/animal.

In an embodiment of the present disclosure, the conditional generative model is trained using medical images of different modalities.

The term “modality” refers to the specific imaging technique or method used to generate medical images. Common modalities include X-ray, computed tomography (CT), magnetic resonance imaging (MRI), ultrasound, positron emission tomography (PET), and single-photon emission computed tomography (SPECT). Each modality offers unique advantages and is used to visualize different aspects of the body, such as bones, soft tissues, blood flow, or metabolic activity.

In a further step, a semantic representation is generated from each image of the variety of medical images.

A “semantic representation” of a medical image refers to a mathematical or computational representation that captures the meaning or semantics of the medical image. It aims to encode the high-level information and concepts present in the medical image, allowing machines to understand and reason about the content of the medical image. The learned semantic representation of a medical image may be a vector or a matrix or a tensor or a set of numerical values that encodes the characteristics and semantic information of the medical image.

An image encoder is used for generating a semantic representation.

An “image encoder” is a component or model designed to transform image data into a semantic representation. This transformation is aimed at capturing the essential visual features and patterns within the image. Image encoders are commonly used in tasks such as image classification, object detection, and image generation. The image encoder can be an artificial neural network and/or a transformer network, for example.

In an embodiment of the present disclosure, the semantic representations of the medical images are embeddings generated with an encoder of a pre-trained autoencoder.

An “embedding” is a numerical representation of a medical image, usually in the form of a vector or matrix. In such an embedding, such features of a medical image can be summarized that make up the content of the medical image. Thus, the embedding can be a compressed representation of the medical image.

An “autoencoder” is a type of neural network architecture that is primarily used for unsupervised learning and dimensionality reduction. It is designed to learn a compressed representation, or embedding, of the input data and then reconstruct the original data from this embedding. An autoencoder usually comprises two main components: an encoder and a decoder. The encoder takes the input data and maps it to a lower-dimensional latent space representation, also known as the embedding or “latent”. The decoder then takes this embedding and reconstructs the original input data from it. The objective of an autoencoder is to minimize the reconstruction error, which encourages the model to learn a compressed representation that captures the most salient features of the input data.

An autoencoder is often implemented as an artificial neural network that may comprise a convolutional neural network (CNN) to extract features from medical images as input data. An example of such an autoencoder is the U-Net (see, e.g., O. Ronneberger et al.: U-net: Convolutional networks for biomedical image segmentation, International Conference on Medical image computing and computer-assisted intervention, 234-241, Springer, 2015, DOI: 10.1007/978-3-319-24574-4_28). CNNs may also have a mix of convolutional and linear/attention blocks, incorporating elements from transformer architectures. They can also have full transformer blocks. Further examples of autoencoders are sparse autoencoders, denoising autoencoders, variational autoencoders (VAEs), and generative adversarial networks (GANs). The autoencoder can be (pre-)trained based on (non-annotated) images. The images can be medical images, but they can also be other images or include other images.

Autoencoders can be (pre-)trained using a self-supervised learning approach, meaning they do not require labeled data for training.

The term “pre-trained” refers to a model that has been trained on a large dataset in advance and can then be used for various tasks, either directly or after finetuning. Pre-training involves training a model on a task or dataset that is typically different from the specific task for which the model will be used later. The pre-training process involves exposing the model to a vast amount of data and allowing it to learn general patterns and representations from that data. This enables the model to capture common features and structures that are useful across various related tasks. The model is typically trained using unsupervised or self-supervised learning methods, where the labels or annotations are generated automatically or do not require human intervention. Once the pre-training phase is complete, the model's weights and parameters are saved and made publicly available. Other researchers or practitioners can then use this pre-trained model as a starting point for their own tasks. By leveraging the pre-trained model, they can benefit from the learned representations and potentially achieve better performance even with limited training data.

“Self-supervised learning” is a type of machine learning paradigm where a model is trained to learn from the data itself, without the need for human-labelled annotations. Instead of relying on external labels provided by humans, the model generates its own supervisory signals from the input data, making it a form of unsupervised learning.

In another embodiment of the present disclosure, the semantic representations of the medical images are embeddings generated with the help of a pre-trained vision transformer.

A vision transformer (ViT) is a type of artificial neural network that has been adapted from transformers, a model architecture that was originally designed for natural language processing tasks, to handle tasks related to images. The core idea behind transformers is the use of attention mechanisms which allow the model to weigh the importance of different parts of the input data when making predictions.

In the context of computer vision, a vision transformer may treat an image much like a sequence of words. An image may be divided into a grid of fixed-size patches, and these patches may then be flattened into a one-dimensional sequence of vectors. Each vector serves as a token, analogous to a word in a sentence. To retain positional information, positional embeddings may be added to these patch embeddings since the original transformer architecture relies on the assumption that the input is sequential.

The resulting sequence of patch embeddings, enriched with positional information, is fed into the transformer encoder. Inside the encoder, multiple layers of multi-head attention and feed-forward neural networks process the sequence. Through attention, the model can learn to focus on different parts of the image and understand the relationships between various patches, which is crucial for recognizing patterns and objects in the image.

Vision transformers have been shown to achieve excellent performance on various image classification benchmarks, often outperforming traditional convolutional neural networks (CNNs) which have been the dominant approach in computer vision for many years. Unlike CNNs, vision transformers do not rely on the inductive biases of locality and translation invariance to the same extent, which means they require more data to learn from but can also generalize better once they have learned the relevant patterns.

Due to their effectiveness and flexibility, vision transformers are used in a wide range of applications beyond image classification, including object detection, semantic segmentation, and image generation (see, e.g., T. Lin et al.: A survey of transformers, AI Open, Volume 3, 2022, Pages 111-132; S. Khan et al.: Transformers in Vision: A Survey, arXiv:2101.01169v5).

The vision transformer may have been pre-trained in a DINO approach. DINO (self-DIstillation with NO labels) is a self-supervised learning method specifically designed to improve the performance of vision transformers in image classification tasks (see, e.g., M. Caron et al.: Emerging Properties in Self-Supervised Vision Transformers, arXiv:2104.14294v2).

DINO introduces a novel approach to self-supervised learning for vision transformers by leveraging two main components: clustering and distillation. Initially, the model is trained to cluster augmented views of the input data. This clustering helps the model to discover semantically similar instances within the dataset. Then, a distillation process is performed, where the model learns to transfer knowledge from a teacher network to a student network. The teacher network provides soft targets, or guidance, to the student network, which helps improve the student's performance. By combining clustering and distillation, DINO enables the model to learn more robust and discriminative representations, leading to better generalization and performance on downstream tasks such as image classification.

In another embodiment of the present disclosure, the vision transformer is pre-trained using a DiNOv2 approach. DiNOv2 (DIscriminative NOise Contrastive Learning V2) is another self-supervised approach for training vision transformers (see, e.g., M. Oquab et al.: DINOv2: Learning Robust Visual Features without Supervision, arXiv:2304.07193v1).

In another embodiment of the present disclosure, the semantic representations of the medical images are embeddings generated with the help of a model that combines vision transformer(s) and convolutional neural network(s).

A common way to combine CNNs and transformers is to use a CNN as a feature extractor at the beginning of the model. The CNN may process the input image and generate a set of feature maps that capture the local structures within the image. These feature maps may then be used as input to the transformer. The transformer may then focus on capturing the global dependencies between the features extracted by the CNN. This combination allows the model to benefit from the inductive biases of CNNs, such as translation invariance and locality, while also utilizing the global receptive field of transformers.

Another approach is to intersperse transformer layers within a CNN architecture. In this setup, convolutional layers may be used for early-stage feature extraction, and transformer layers are inserted in between convolutional layers to model long-range dependencies at various stages of the network. This can enhance the representational power of the network without completely abandoning the proven structure of CNNs.

There are also architectures where convolutional operations are integrated into the transformer layers themselves. For instance, convolutional embeddings can be used instead of linear embeddings to process patches before feeding them into the transformer. Additionally, convolutional layers can be used within the transformer's feed-forward networks to maintain some degree of locality.

The benefit of combining CNNs and transformers lies in the synergy between the local processing of CNNs and the global processing of transformers. CNNs are excellent at capturing local patterns and textures in an image, which is useful for many low-level vision tasks. Transformers, on the other hand, excel at capturing the overall structure and relationships between different parts of the image, which is beneficial for understanding the image as a whole. By combining these two architectures, models can be more data-efficient, as they can utilize the inductive biases of CNNs to learn from fewer examples. They can also be more computationally efficient, as the local processing of CNNs can reduce the sequence length that the transformer has to handle, leading to reduced computational complexity. Moreover, such hybrid models can be more robust and generalize better to new, unseen data by integrating both local and global contextual information.

Like the autoencoder, the vision transformer is preferably pre-trained. The vision transformer may have been pre-trained in a supervised, self-supervised or unsupervised approach.

In another embodiment of the present disclosure, the semantic representations of the medical images are embeddings generated with the help of an image encoder of a pre-trained CLIP model.

CLIP (Contrastive Language-Image Pretraining) is a framework in the field of machine learning that combines natural language processing and computer vision to understand and generate multimodal representations of images and text. CLIP encodes text and image in same embedding space (see, e.g., A. Radford et al.: Learning Transferable Visual Models From Natural Language Supervision, arXiv:2103.00020v1).

CLIP is (pre-)trained in a self-supervised manner, where large-scale datasets of images and their associated text are used to learn joint representations. The model is trained to associate images and their textual descriptions by maximizing their similarity in the learned embedding space. This allows CLIP to understand and reason about images and text in a shared semantic space. The base model uses a ViT-L/14 transformer architecture as an image encoder and uses a masked self-attention transformer as a text encoder. These encoders are trained to maximize the similarity of (image, text) pairs via a contrastive loss.

The key innovation of CLIP is its ability to generalize across different domains and tasks. By training on a diverse range of image and text pairs, CLIP can perform a variety of tasks without task-specific fine-tuning. For example, CLIP can perform zero-shot image classification, where it can classify images into categories it has never seen during training, solely based on textual descriptions.

The semantic representations of the medical images can be generated in the course of (during) the training of the conditional generative model and/or in advance.

In a next step, the conditional generative model is trained in a self-supervised training procedure using the variety of medical images and their semantic representations as training data, wherein the conditional generative model is trained to reconstruct each medical image or a portion thereof using the respective semantic representation of the medical image as a conditioning input.

In other words, the conditional generative model learns the semantic meaning of medical images, i.e. the content of medical images and/or the relationships between objects in medical images and/or the relationships between structures in medical images.

In one embodiment of the present disclosure, at least a portion of the semantic representations are masked in whole or in part. Thereby, one or more parts of the semantic representation, also referred to as “tokens” in the present disclosure, are set to zero. The tokens that are masked can be selected randomly or specifically. The proportion of masked tokens can be constant or can be varied. Mixed forms are also conceivable. Semantic representations of medical images can be masked in different ways. This procedure, also known as conditioning drop-out, leads on the one hand to an enlargement of the training data set. On the other hand, the conditioning drop-out leads to the conditional generative model gaining global information about the medical image from local information of a medical image.

Once the conditional generative model has been trained, it can be used for automated segmentation. It can be used to segment medical images, even if the medical images were not used to train the conditional generative model (so-called unseen medical images) and/or the training of the conditional generative model was not intended to segment images: the training task was a reconstruction and not a segmentation task.

For the segmentation, a semantic representation of an unseen medical image is first generated using the image encoder. The unseen medical image is entered into the trained conditional generative model. The trained conditional generative model reconstructs the unseen medical image; the semantic representation of the unseen medical image is used as a condition.

In a further step one or more attention maps are determined. The one or more attention maps result at least in part from the reconstruction of the unseen medical image by the trained conditional generative model.

An attention map may refer to a representation that highlights the regions of an input image that are deemed important by a model when making a prediction or performing a specific task. This map may be used to illustrate where the model focuses its “attention” within the input image. Attention maps are described, for example, in: C. Ma et al.: DiffusionSeg: Adapting Diffusion Towards Unsupervised Object Discovery, arXiv:2303.09813v1; W. Wu et al.: DiffuMask: Synthesizing Images with Pixel-level Annotations for Semantic Segmentation Using Diffusion Models, arXiv:2303.11681v4; J. Tian et al.: Diffuse, Attend, and Segment: Unsupervised Zero-Shot Segmentation using Stable Diffusion, arXiv:2308.12469v3.

The one or more attention maps may comprise one or more self-attention maps derived from the conditional generative model. “Self-attention” is a mechanism that allows a model to weigh the importance of a pixel's or voxel's values at a specific position in relation to all other positions in the image. This is done for all positions, resulting in an attention map that provides a kind of heatmap of where the model pays attention when generating an image. A “self-attention map” is a matrix that describes the attention scores between all pairs of positions in the image. Each entry in the matrix represents the attention score between a pair of pixels/voxels, indicating how much influence one pixel/voxel has on another during the generation process.

Self-attention inside one image indicates pairwise semantic similarity between image elements (e.g., pixels or voxels), thus self-attention may describe coherence. “Coherence” refers to the consistency and correlation between different parts of an image.

The one or more self-attention maps may be derived from one or more self-attentions layers of the conditional generative model as described in J. Tian et al.: Diffuse, Attend, and Segment: Unsupervised Zero-Shot Segmentation using Stable Diffusion, arXiv:2308.12469v3, for example. Preferably more than one self-attention map is derived from more than one self-attention layer. The number of self-attention maps may be 2, 3, 4, 5, 6, 7, 8, 9, 10, 11, 12, 13, 14, 15, 16, 17, 18, 19, 20 or more than 20. It is possible that a self-attention map is derived from each existing self-attention layer of the conditional generative model.

Different self-attention maps from different self-attention layers can have the same resolution or different resolutions. If they have different resolutions, all self-attention maps can be scaled up and/or down to the same resolution. Preferably, all self-attention maps are brought to the same, largest available resolution. In other words: if there are one or more self-attention maps whose resolution is greater than that of all other self-attention maps, then the resolutions of the other self-attention maps are preferably scaled up to the resolution of the self-attention map(s) with the greatest resolution.

Different self-attention maps can be merged into one self-attention map. Merging different self-attention maps into one self-attention map can be done in an iterative approach as described in J. Tian et al.: Diffuse, Attend, and Segment: Unsupervised Zero-Shot Segmentation using Stable Diffusion, arXiv:2308.12469v3, for example.

For merging different self-attention maps into one self-attention map, anchor points can be selected. Each anchor point is a potential starting point for a segmented object (an object proposal).

The anchor points can be the intersection points of a grid with equal distances between the grid lines, as described in J. Tian et al.: Diffuse, Attend, and Segment: Unsupervised Zero-Shot Segmentation using Stable Diffusion, arXiv:2308.12469v3. However, the anchor points can also be selected according to other aspects; they do not have to be evenly spaced. The number of anchor points can be between 10 and 100; however, it can also be greater than 100. Self-attention maps can be derived for each anchor point.

For each anchor point, those attention maps can be merged for which a predefined similarity exceeds a predefined threshold value. The predefined similarity can be a similarity measure for the similarity of probability distributions. A well-known measure for the similarity of probability distributions is, for example, the Kullback-Leibler divergence (KL divergence). It should be noted that the KL divergence is a distance measure. In this case, those self-attention maps whose KL divergence is smaller than a predefined threshold value are merged. It should be noted that other similarity measures and/or distance measures can also be used to determine the similarity between two or more self-attention maps. The self-attention maps that have a minimum similarity can be combined for each anchor point, e.g., by averaging (e.g. arithmetic mean).

All merged self-attention maps may be saved in a proposal list. Note that the first iteration does not reduce the number of proposals compared to the number of anchor points. From the second iteration onwards, the merging algorithm disclosed in J. Tian et al.: Diffuse, Attend, and Segment: Unsupervised Zero-Shot Segmentation using Stable Diffusion, arXiv:2308.12469v3 starts merging self-attention maps and reducing the number of proposals at the same time by calculating the distance between an element from the proposal list and all elements from the same list and merging elements with a distance smaller than the threshold without replacement.

The iterative attention merging step yields a list of object proposals in the form of attention maps (probability maps). Each proposal in the list potentially contains the activation of a single object. To convert the list into a valid segmentation mask, non-maximum suppression (NMS) can be used, for example.

The one or more attention maps may comprise one or more cross-attention maps derived from one or more cross-attention layers of the conditional generative model. Such a cross-attention map may indicate the attention weights for the individual image elements of the reconstructed medical image in relation to the elements of the semantic representation. In other words, a cross-attention map may specify an attention score for each pixel/voxel or group of pixels/voxels of the reconstructed medical image that the trained conditional generative model assigns to an element or group of elements of the semantic representation when reconstructing the medical image and/or vice versa. In other words, in the cross-attention map, the meaning of an element or a group of elements of the semantic representation for the reconstruction of each image element or group of image elements of the medical image and/or vice versa can be visualized.

Cross-attention indicates locality between the conditioning semantic representation and the reconstructed medical image, thus cross-attention can coarsely describe objectness. “Objectness” refers to a measure of the likelihood that a particular portion of an image contains an object of interest, irrespective of the class of that object.

Cross-attention maps can be generated in the same way as self-attention maps. Cross-attention maps can be merged with self-attention maps.

The one or more attention maps may comprise one or more self-attention maps derived from the image encoder. The generation of an attention map from an image encoder is described, for example, in: M. Caron et al.: Emerging Properties in Self-Supervised Vision Transformers, arXiv:2104.14294v2.

Self-attention maps derived from the image encoder can be merged with self-attention maps and/or cross-attention maps derived from the generative diffusion model.

As described above, segmentation masks can be generated from the attention maps. Different segmentation masks can be combined to generate a segmented medical image in which each object may be displayed in a different colour, for example.

The aspects of the present disclosure are explained in more detail below with reference to examples and drawings, without wishing to limit the disclosure to the examples or the features and combinations of features shown in the drawings. If the same reference signs are used in different drawings, they have the same meaning.

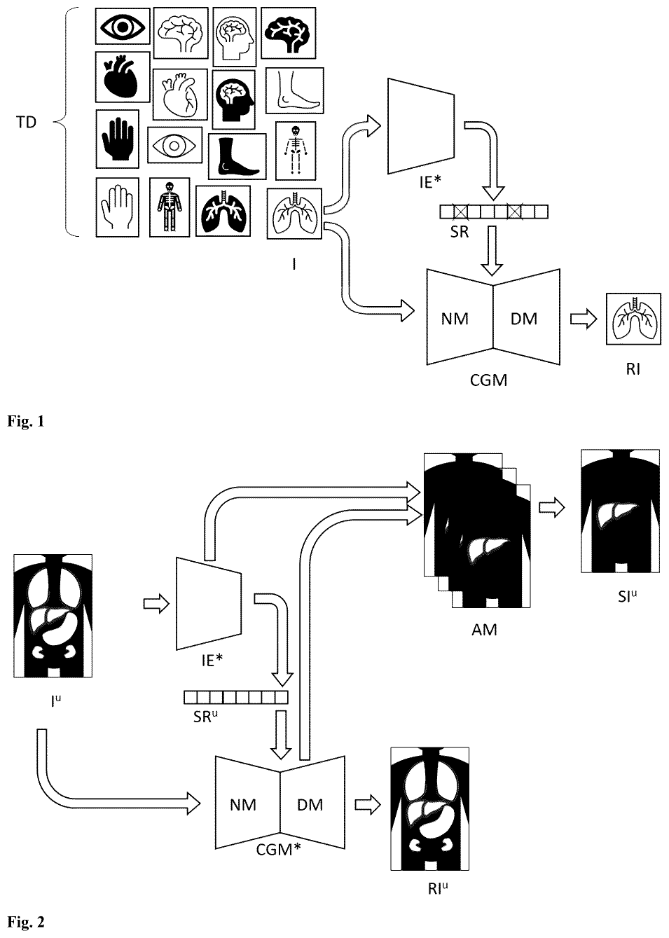

FIG. 1 shows schematically by way of example the training of the machine learning model of the present disclosure.

The machine learning model is a conditional generative model CGM comprising a noising model NM (encoder) and a denoising model DM (decoder).

The conditional generative model CGM is configured and trained to reconstruct each medical image I of a training data set TD.

In other words, the conditional generative model CGM is configured to receive a medical image I, apply noise to the image (or a latent representation of the image in case the image generation model is a latent diffusion model) in a defined number of steps, and reconstruct the medical image I (or the latent representation thereof) from the noisy data and output it as a reconstructed medical image RI.

The training data TD comprises a variety of medical images. The medical images may be fully or partially non-annotated (unlabelled) medical images. In other words: annotations (labels) are not required to train the conditional generative model CGM.

The reconstruction of each medical image I is based on a condition. The condition is a semantic representation SR of the medical image I. The semantic representation SR of the medical image I is generated with a pre-trained image encoder IE*. The asterisk * in the reference sign IE* indicates that the pre-trained encoder IE* is not trained when the conditional generative model CGM is trained. However, it is generally possible to include the pre-trained image encoder IE* in the training. For example, it is possible to first train the conditional generative model CGM and have the parameters of the pre-trained image encoder IE* locked and then, in a further step, extend the training to the pre-trained image encoder IE* in an end-to-end training process. Other training procedures are also conceivable.

As described in this disclosure, the image encoder IE* may be an encoder of an autoencoder or an image encoder of a vision transformer or an image encoder of a CLIP model or another encoder that generates a semantic representation of an image.

It is also possible to use several (different) image encoders that generate different semantic representations. The different semantic representations can be combined with each other to form a condition (e.g., by concatenation or pooling).

As shown in FIG. 1 the semantic representation SR can be partially masked (indicated by the crosses).

The conditional generative model CGM is usually trained in a self-supervised training process. The training process usually comprises the following steps for each medical image I of the variety of medical images:
inputting the medical image I and a semantic representation SR of the medical image I into the conditional generative model CGM,
receiving a reconstructed medical image RI as output of the conditional generative model CGM,
determining deviations between the medical image I and the reconstructed medical image RI (e.g., using a loss function),
reducing the deviations by modifying parameters of the conditional generative model CGM.

The known methods of data augmentation can be used to enlarge the training data set. It is also possible to use augmented medical images as input data and non-augmented medical images as target data. The semantic representations are preferably generated from non-augmented medical images.

The training of the conditional generative model can be ended when a stop criterion is met. Such a stop criterion can be for example: a predefined maximum number of training steps/cycles/epochs has been performed, deviations between output data and target data can no longer be reduced by modifying the model parameters, a predefined minimum of the loss function is reached, and/or an extreme value (e.g., maximum or minimum) of another performance value is reached.

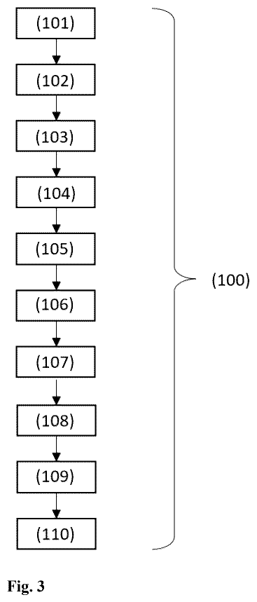

Through the training, the conditional generative model learns structures in medical images and their relationships to each other. The trained conditional generative model can be used to segment an unseen medical image. This is shown schematically as an example in FIG. 2.

FIG. 2 shows schematically by way of example the segmentation of an unseen medical image using the trained conditional generative model.

The unseen medical image 1^{st} shows a human body, including the lungs, liver, stomach and kidneys.

A semantic representation SR^{u} of the unseen medical image I^{u} is generated with the help of the image encoder IE*.

The unseen medical image I^{u} and the semantic representation SR^{u} are fed to the trained conditional generative model CGM*. The trained conditional generative model CGM* generates a reconstructed medical image RI^{u} based on the unseen medical image I^{u} using the semantic representation SR as a condition.

One or more attention maps AM are generated from one or more attention layers of the trained conditional generative model CGM* and optionally the image encoder IE*. A segmented medical image SI^{u} is generated from the one or more attention maps AM. In this example, the liver was segmented.

FIG. 3 shows schematically by way of example, the computer-implemented method of the present disclosure in from of a flow chart.

The method (100) comprises the steps:
(101) providing a training data set, the training data set comprising a variety of medical images,
(102) for each medical image of the variety of medical images: generating a semantic representation of the medical image using an image encoder,
(103) providing a conditional generative model,
(104) training the conditional generative model on the training data set to reconstruct the medical images in a self-supervised training procedure using the semantic representations as conditions,
(105) receiving an unseen medical image,
(106) generating a semantic representation of the unseen medical image using the image encoder,
(107) inputting the unseen medical image into the trained conditional generative model, thereby causing the trained conditional generative model to reconstruct the unseen medical image, wherein the semantic representation of the unseen medical image is used as condition,
(108) determining one or more attention maps resulting at least in part from the reconstruction of the unseen medical image by the trained conditional generative model,
(109) generating a segmented medical image based on the one or more attention maps,
(110) outputting the segmented medical image.

The operations in accordance with the teachings herein may be performed by at least one computer system specially constructed for the desired purposes or general-purpose computer system specially configured for the desired purpose by at least one computer program stored in a typically non-transitory computer readable storage medium.

A “computer system” is a system for electronic data processing that processes data by means of programmable calculation rules. Such a system usually comprises a “computer”, that unit which comprises a processor for carrying out logical operations, and also peripherals.

In computer technology, “peripherals” refer to all devices which are connected to the computer and serve for the control of the computer and/or as input and output devices. Examples thereof are monitor (screen), printer, scanner, mouse, keyboard, drives, camera, microphone, loudspeaker, etc. Internal ports and expansion cards are, too, considered to be peripherals in computer technology.

Computer systems of today are frequently divided into desktop PCs, portable PCs, laptops, notebooks, netbooks and tablet PCs and so-called handhelds (e.g. smartphone); all these systems can be utilized for carrying out the invention.

The term “non-transitory” is used herein to exclude transitory, propagating signals or waves, but to otherwise include any volatile or non-volatile computer memory technology suitable to the application.

The term “computer” should be broadly construed to cover any kind of electronic device with data processing capabilities, including, by way of non-limiting example, personal computers, servers, embedded cores, computing system, communication devices, processors (e.g., digital signal processor (DSP)), microcontrollers, field programmable gate array (FPGA), application specific integrated circuit (ASIC), etc.) and other electronic computing devices.

The term “process” as used above is intended to include any type of computation or manipulation or transformation of data represented as physical, e.g., electronic, phenomena which may occur or reside e.g., within registers and/or memories of at least one computer or processor. The term processor includes a single processing unit or a plurality of distributed or remote such units.

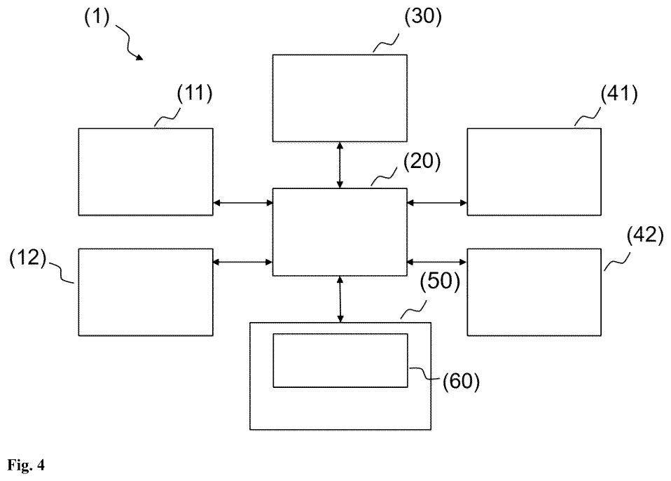

FIG. 4 illustrates a computer system (1) according to some example implementations of the present disclosure in more detail.

Generally, a computer system of exemplary implementations of the present disclosure may be referred to as a computer and may comprise, include, or be embodied in one or more fixed or portable electronic devices. The computer may include one or more of each of a number of components such as, for example, a processing unit (20) connected to a memory (50) (e.g., storage device).

The processing unit (20) may be composed of one or more processors alone or in combination with one or more memories. The processing unit (20) is generally any piece of computer hardware that is capable of processing information such as, for example, data, computer programs and/or other suitable electronic information. The processing unit (20) is composed of a collection of electronic circuits some of which may be packaged as an integrated circuit or multiple interconnected integrated circuits (an integrated circuit at times more commonly referred to as a “chip”). The processing unit (20) may be configured to execute computer programs, which may be stored onboard the processing unit (20) or otherwise stored in the memory (50) of the same or another computer.

The processing unit (20) may be a number of processors, a multi-core processor or some other type of processor, depending on the particular implementation. For example, it may be a central processing unit (CPU), a field programmable gate array (FPGA), a graphics processing unit (GPU) and/or a tensor processing unit (TPU). Further, the processing unit (20) may be implemented using a number of heterogeneous processor systems in which a main processor is present with one or more secondary processors on a single chip. As another illustrative example, the processing unit (20) may be a symmetric multi-processor system containing multiple processors of the same type. In yet another example, the processing unit (20) may be embodied as or otherwise include one or more ASICs, FPGAs or the like. Thus, although the processing unit (20) may be capable of executing a computer program to perform one or more functions, the processing unit (20) of various examples may be capable of performing one or more functions without the aid of a computer program. In either instance, the processing unit (20) may be appropriately programmed to perform functions or operations according to example implementations of the present disclosure.

The memory (50) is generally any piece of computer hardware that is capable of storing information such as, for example, data, computer programs (e.g., computer-readable program code (60)) and/or other suitable information either on a temporary basis and/or a permanent basis. The memory (50) may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD, Blu-ray disk or the like. In various instances, the memory may be referred to as a computer-readable storage medium or data memory. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory (50), the processing unit (20) may also be connected to one or more interfaces for displaying, transmitting and/or receiving information. The interfaces may include one or more communications interfaces and/or one or more user interfaces. The communications interface(s) may be configured to transmit and/or receive information, such as to and/or from other computer(s), network(s), database(s) or the like. The communications interface may be configured to transmit and/or receive information by physical (wired) and/or wireless communications links. The communications interface(s) may include interface(s) (41) to connect to a network, such as using technologies such as cellular telephone, Wi-Fi, satellite, cable, digital subscriber line (DSL), fiber optics and the like. In some examples, the communications interface(s) may include one or more short-range communications interfaces (42) configured to connect devices using short-range communications technologies such as NFC, RFID, Bluetooth, Bluetooth LE, ZigBee, infrared (e.g., IrDA) or the like.

The user interfaces may include a display (30). The display (screen) may be configured to present or otherwise display information to a user, suitable examples of which include a liquid crystal display (LCD), light-emitting diode display (LED), plasma display panel (PDP) or the like. The user input interface(s) (11) may be wired or wireless and may be configured to receive information from a user into the computer system (1), such as for processing, storage and/or display. Suitable examples of user input interfaces include a microphone, image or video capture device, keyboard or keypad, joystick, touch-sensitive surface (separate from or integrated into a touchscreen) or the like. In some examples, the user interfaces may include automatic identification and data capture (AIDC) technology (12) for machine-readable information. This may include barcode, radio frequency identification (RFID), magnetic stripes, optical character recognition (OCR), integrated circuit card (ICC), and the like. The user interfaces may further include one or more interfaces for communicating with peripherals such as printers and the like.

As indicated above, program code instructions (60) may be stored in memory (50) and executed by processing unit (20) that is thereby programmed, to implement functions of the systems, subsystems, tools and their respective elements described herein. As will be appreciated, any suitable program code instructions (60) may be loaded onto a computer or other programmable apparatus from a computer-readable storage medium to produce a particular machine, such that the particular machine becomes a means for implementing the functions specified herein. These program code instructions (60) may also be stored in a computer-readable storage medium that can direct a computer, processing unit or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions (60) may be retrieved from a computer-readable storage medium and loaded into a computer, processing unit or other programmable apparatus to configure the computer, processing unit or other programmable apparatus to execute operations to be performed on or by the computer, processing unit or other programmable apparatus.

Retrieval, loading and execution of the program code instructions (60) may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions (60) may produce a computer-implemented process such that the instructions executed by the computer, processing circuitry or other programmable apparatus provide operations for implementing functions described herein.

Execution of instructions by processing unit, or storage of instructions in a computer-readable storage medium, supports combinations of operations for performing the specified functions. In this manner, a computer system (1) may include processing unit (20) and a computer-readable storage medium or memory (50) coupled to the processing circuitry, where the processing circuitry is configured to execute computer-readable program code instructions (60) stored in the memory (50). It will also be understood that one or more functions, and combinations of functions, may be implemented by special purpose hardware-based computer systems and/or processing circuitry which perform the specified functions, or combinations of special purpose hardware and program code instructions.

The computer system of the present disclosure may be in the form of a laptop, notebook, netbook, and/or tablet PC; it may also be a component of an MRI scanner, a CT scanner, an ultrasound diagnostic machine or any other device for the generation and/or processing of medical images.

In another aspect, the present disclosure provides a computer program product. Such a computer program product comprises a non-volatile data carrier, such as a CD, a DVD, a USB stick or other medium for storing data. A computer program is stored on the data carrier. The computer program can be loaded into a working memory of a computer system (in particular, into a working memory of a computer system of the present disclosure), where it can cause the computer system to perform the following steps:
providing a training data set, the training data set comprising a variety of medical images,
for each medical image of the variety of medical images: generating a semantic representation of the medical image using an image encoder,
providing a conditional generative model,
training the conditional generative model on the training data set to reconstruct the medical images in a self-supervised training procedure using the semantic representations as conditions,
receiving an unseen medical image,
generating a semantic representation of the unseen medical image using the image encoder,
inputting the unseen medical image into the trained conditional generative model, thereby causing the trained conditional generative model to reconstruct the unseen medical image, wherein the semantic representation of the unseen medical image is used as condition,
determining one or more attention maps resulting at least in part from the reconstruction of the unseen medical image by the trained conditional generative model,
generating a segmented medical image based on the one or more attention maps,
outputting the segmented medical image

1. A computer-implemented method comprising the steps:
providing a training data set, the training data set comprising a variety of medical images,
for each medical image of the variety of medical images: generating a semantic representation of the medical image using an image encoder,
providing a conditional generative model,
training the conditional generative model on the training data set to reconstruct the medical images in a self-supervised training procedure using the semantic representations as conditions,
receiving an unseen medical image,
generating a semantic representation of the unseen medical image using the image encoder,
inputting the unseen medical image into the trained conditional generative model, thereby causing the trained conditional generative model to reconstruct the unseen medical image, wherein the semantic representation of the unseen medical image is used as condition,
determining one or more attention maps resulting at least in part from the reconstruction of the unseen medical image by the trained conditional generative model,
generating a segmented medical image based on the one or more attention maps, and
outputting the segmented medical image.

2. The method of claim 1, wherein the variety of medical images comprises radiological images, and the unseen medical image is a radiological image.

3. The method of claim 1, wherein the conditional generative model comprises a conditional diffusion model.

4. The method of claim 1, wherein training of the conditional generative model comprises, for each medical image of the variety of medical images:
inputting the medical image and the semantic representation of the medical image into the conditional generative model,
receiving a reconstructed medical image as output of the conditional generative model,
determining deviations between the medical image and the reconstructed medical image, and
reducing the deviations by modifying parameters of the conditional generative model.

5. The method of claim 1, wherein training of the conditional generative model comprises, for at least a portion of the variety of medical images:
masking at least a portion of the semantic representation of the medical image,
inputting the medical image and the masked semantic representation of the medical image into the conditional generative model,
receiving a reconstructed medical image as output of the conditional generative model,
determining deviations between the medical image and the reconstructed medical image,
reducing the deviations by modifying parameters of the conditional generative model.

6. The method of claim 1, wherein the image encoder comprises an encoder of a pre-trained autoencoder.

7. The method of claim 1, wherein the image encoder comprises a pre-trained vision transformer.

8. The method of claim 1, wherein the one or more attention maps comprise one or more self-attention maps derived from one or more self-attention layers of the conditional generative model.

9. The method of claim 1, wherein the one or more attention maps comprise one or more cross-attention maps derived from one or more cross-attention layers of the conditional generative model.

10. The method of claim 1, wherein the one or more attention maps comprise one or more self-attention maps derived from one or more self-attention layers of the image encoder.

11. The method of claim 1,
wherein determining one or more attention maps resulting at least in part from the reconstruction of the unseen medical image by the trained conditional generative model comprises:
determining more than one attention maps, wherein the attention maps are derived from one or more self-attention layers and/or cross-attention layers of the conditional generative model and/or from one or more self-attention layers of the image encoder,
combining the attention maps into a combined attention map,
wherein generating the segmented medical image based on the one or more attention maps, comprises:
generating the segmented medical image based on the combined attention map.

12. The method of claim 11, wherein combining the attention maps comprises:
generating a combined attention map by averaging the attention maps.

13. The method of claim 1, wherein generating the segmented medical image based on the one or more attention maps, comprises:
creating a mask by binarizing the one or more attention maps or the combined attention map,
generating the segmented medical image by masking the unseen medical using the mask.

14. A computer system comprising:
a processor; and
a memory storing an application program configured to perform, when executed by the processor, an operation, the operation comprising:
providing a training data set, the training data set comprising a variety of medical images,
for each medical image of the variety of medical images: generating a semantic representation of the medical image using an image encoder,
providing a conditional generative model,
training the conditional generative model on the training data set to reconstruct the medical images in a self-supervised training procedure using the semantic representations as conditions,
receiving an unseen medical image,
generating a semantic representation of the unseen medical image using the image encoder,
inputting the unseen medical image into the trained conditional generative model, thereby causing the trained conditional generative model to reconstruct the unseen medical image, wherein the semantic representation of the unseen medical image is used as condition,
determining one or more attention maps resulting at least in part from the reconstruction of the unseen medical image by the trained conditional generative model,
generating a segmented medical image based on the one or more attention maps, and
outputting the segmented medical image.

15. A non-transitory computer readable storage medium having stored thereon software instructions that, when executed by a processor of a computer system, cause the computer system to execute the following steps:
providing a training data set, the training data set comprising a variety of medical images,
for each medical image of the variety of medical images: generating a semantic representation of the medical image using an image encoder,
providing a conditional generative model,
training the conditional generative model on the training data set to reconstruct the medical images in a self-supervised training procedure using the semantic representations as conditions,
receiving an unseen medical image,
generating a semantic representation of the unseen medical image using the image encoder,
inputting the unseen medical image into the trained conditional generative model, thereby causing the trained conditional generative model to reconstruct the unseen medical image, wherein the semantic representation of the unseen medical image is used as condition,
determining one or more attention maps resulting at least in part from the reconstruction of the unseen medical image by the trained conditional generative model,
generating a segmented medical image based on the one or more attention maps,
outputting the segmented medical image.
